(19) United States
(12) Patent Application Publication
(10) Pub. No.: US 2026/0340162 A1
(43) Pub. Date: Oct. 29, 2026

(54) ATTRIBUTE POLICIES FOR PROTECTING A COLLECTION OF DATA

(71) Applicant: International Business Machines Corporation, Armonk, NY (US)

(72) Inventors: Fraser Iain Macintosh, Reading (GB); Christopher J. Vollmar, Mississauga (CA); Rosanna Lickorish, Southampton (GB); Erin M. Farr, Fishkill, NY (US); Juan Carlos Jimenez Fuentes, Forney, TX (US)

(21) Appl. No.: 19/190,410

(22) Filed: Apr. 25, 2025

(51) Int. Cl. G06F 21/62

(52) U.S. Cl. CPC G06F 21/62

(57) ABSTRACT

A method, according to one embodiment, comprises analyzing a plurality of data feeds, the data feeds corresponding to use of different tooling to manage a collection of data. A result of the analysis includes groups of features detected within the data feeds. The method further comprises causing an artificial intelligence (AI) model to use the groups of features to define a context associated with the collection of data, and assigning attribute policies to the groups of features, where the attribute policies are tailored to promote adherence to the context associated with the collection of data. In response to identifying deviation from a first of the attribute policies during the management of the collection of data, an Application Programming Interface (API) action is driven to correct the deviation.

### BACKGROUND

The present invention relates to data, and more specifically, this invention relates to data security.

Data is often stored in networks that include infrastructure components at more than one geographical site. For example, a cloud environment is a network that typically includes remote servers that store portions and/or copies of data. For example, in cases in which a data file exceeds storage capabilities of a first server at a first site, portions of the data file may also be stored on a second server at a second site. In another example, a second data file may be stored on the first site and a copy of the second data file may also be stored on the second site (mirroring) as a precautionary backup measure.

Different storage practices and/or uses of data may be subject to different company mandated security protocols, governing rules, etc., depending on where the data is used and/or stored.

### SUMMARY

A method, according to one embodiment, comprises analyzing a plurality of data feeds, the data feeds corresponding to use of different tooling to manage a collection of data. A result of the analysis includes groups of features detected within the data feeds. The method further comprises causing an artificial intelligence (AI) model to use the groups of features to define a context associated with the collection of data, and assigning attribute policies to the groups of features, where the attribute policies are tailored to promote adherence to the context associated with the collection of data. In response to identifying deviation from a first of the attribute policies during the management of the collection of data, an Application Programming Interface (API) action is driven to correct the deviation.

A computer program product, according to another embodiment, comprises one or more computer-readable storage media, and program instructions stored on the one or more storage media to perform the foregoing method.

A computer system, according to another embodiment, comprises a processor set, one or more computer-readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3 is a flowchart of a method, in accordance with one embodiment of the present invention.

FIG. 4 is a diagram of a data storage environment, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for determining and enforcing attribute policies tailored to protect a collection of data.

In one general embodiment, a method comprises analyzing a plurality of data feeds, the data feeds corresponding to use of different tooling to manage a collection of data. A result of the analysis includes groups of features detected within the data feeds. The method further comprises causing an artificial intelligence (AI) model to use the groups of features to define a context associated with the collection of data, and assigning attribute policies to the groups of features, where the attribute policies are tailored to promote adherence to the context associated with the collection of data. In response to identifying deviation from a first of the attribute policies during the management of the collection of data, an Application Programming Interface (API) action is driven to correct the deviation.

In another general embodiment, a computer program product comprises one or more computer-readable storage media, and program instructions stored on the one or more storage media to perform the foregoing method.

In another general embodiment, a computer system comprises a processor set, one or more computer-readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as attribute policy determination code of block 150 for determining and enforcing attribute policies tailored to protect a collection of data. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

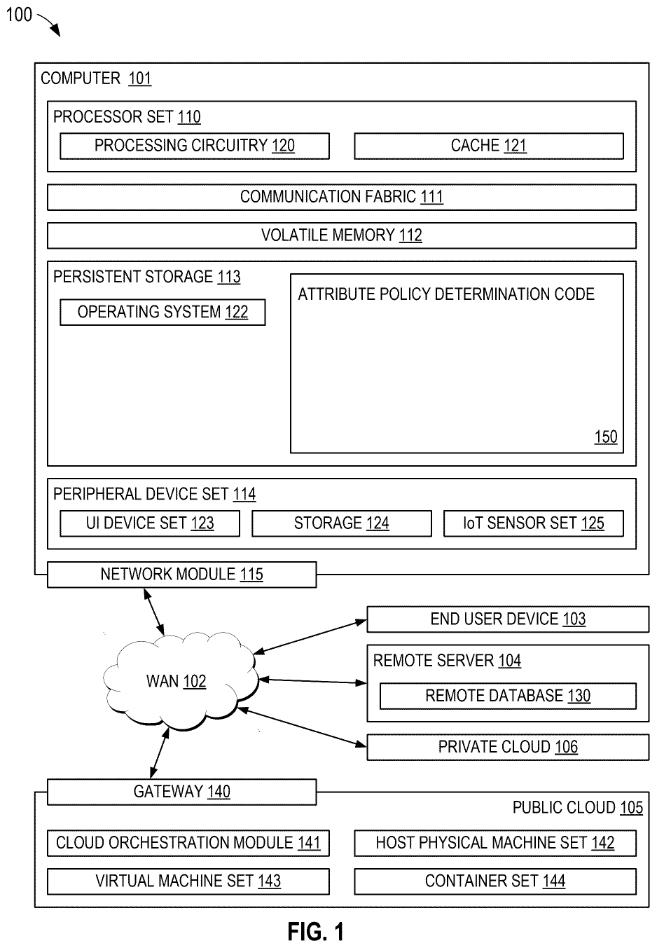

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

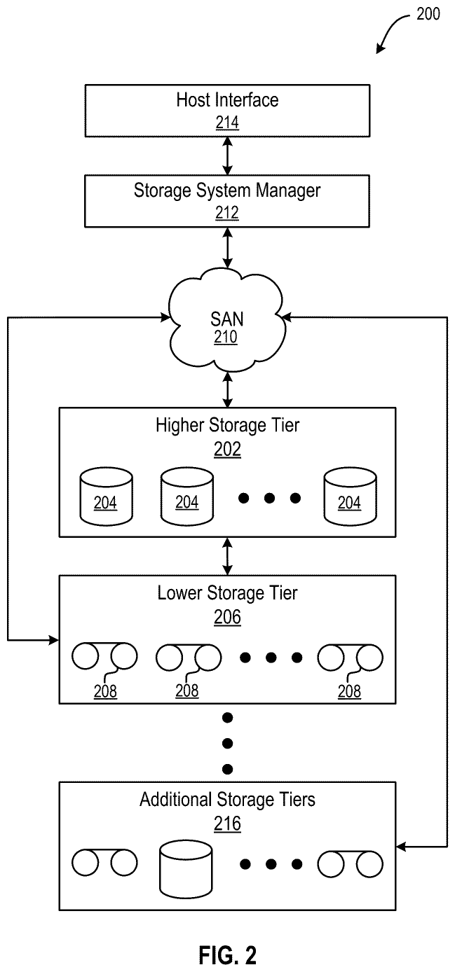

Now referring to FIG. 2, a storage system 200 is shown according to one embodiment. Note that some of the elements shown in FIG. 2 may be implemented as hardware and/or software, according to various embodiments. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a SAN, as shown in FIG. 2, Internet Protocol (IP) network, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

As mentioned elsewhere above, data is often stored in networks that include infrastructure components at more than one geographical site. For example, a cloud environment is a network that typically includes remote servers that store portions and/or copies of data. For example, in cases in which a data file exceeds storage capabilities of a first server at a first site, portions of the data file may also be stored on a second server at a second site. In another example, a second data file may be stored on the first site and a copy of the second data file may also be stored on the second site (mirroring) as a precautionary backup measure and/or disaster recovery measure.

Different storage practices and/or uses of data may be subject to different company mandated security protocols, legislatively mandated protocols, governing rules, etc., depending on where the data is used and/or stored.

Within the technical field of data use and storage, there is a longstanding fundamental disconnect between different workflows, which may include, e.g., data security, data discovery and classification, placement and/or full stack placement analysis, storage protection policies on primary and secondary (backup) and archive platforms, etc. In one use case, there may be organizational silos, visibility silos, relationship silos across the different platforms. For example, a data discovery and classification tool has no way to be linked to different storage platforms (primary, backup, archive). Furthermore, there is no way to see, understand, and visualize where data even sits across the myriad of virtualization and placement technologies used in a data storage environment. This creates a substantial degree of risk that data is not protected, supported, managed, or even available for recovery in a cyber resiliency event according to business control and regulatory guidelines. In addition, determining a data loss or corruption event and the potential workload impact is a forensic activity that can take days to even weeks.

In order to mitigate the deficiencies described above, the techniques of embodiments and approaches described herein establish a connection between the different information streams associated with data. More specifically, these techniques create context (which is also described herein as a “data entity”) for the information streams by analyzing, nominalizing and organizing feed of the workflows. These workflow feeds, in some approaches, are based on one or more of: workload discovery and classification tooling, security monitoring tools, full-stack observability tooling that maps workload placement and relationships, application dependency mapping tooling, primary storage placement and policy information (platform, performance, replication, immutable copy management, etc.), secondary storage and archive tooling (backup management, copy, replication, retention Role-Based Access Control (RBAC), geo-location placement, etc.). An organization of the “data entity” is used to highlight assigned attributes of each workload, validate compliance to organizational or legislative policy for governance, outlines misalignment and creates executable suggestions to align with data requirements, among other technical effects. These techniques furthermore provide an organizational platform for forensic examination of impact in a data exfiltration and/or data corruption event by highlighting what data was impacted from the event and from which systems the impacts are caused, in addition to highlighting risk posed to the data.

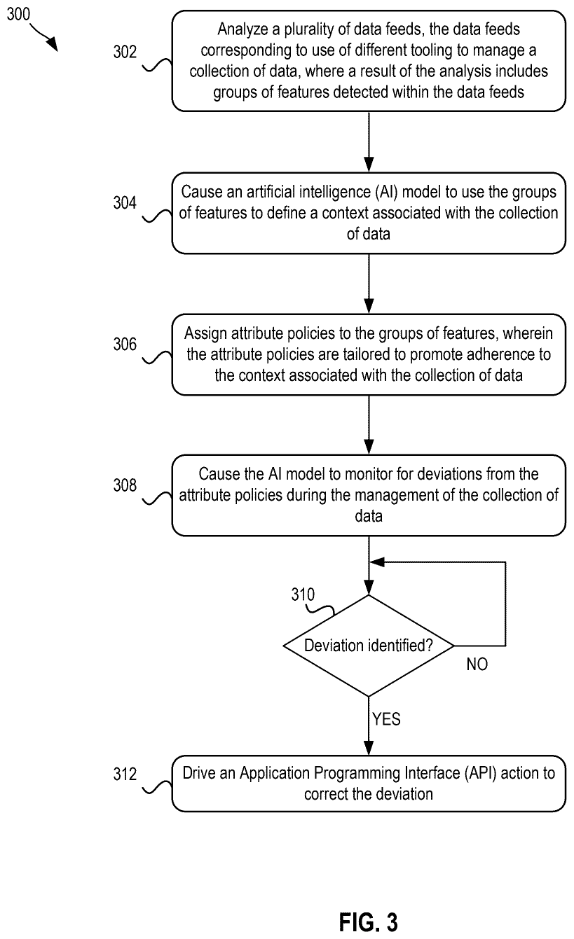

Now referring to FIG. 3, a flowchart of a method 300 is shown according to one embodiment. The method 300 may be performed in accordance with aspects of the present invention in any of the environments depicted in FIGS. 1-4, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

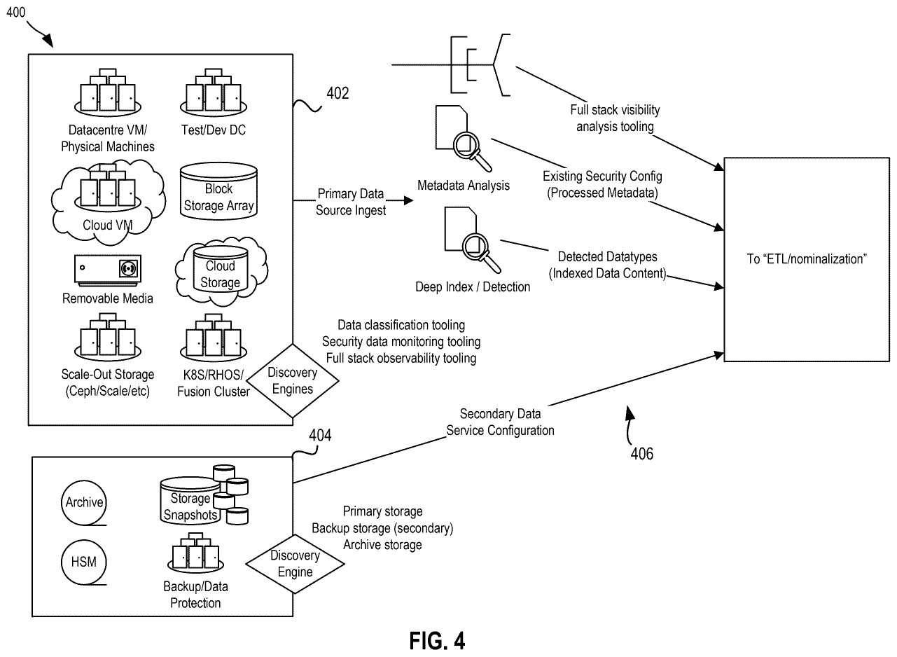

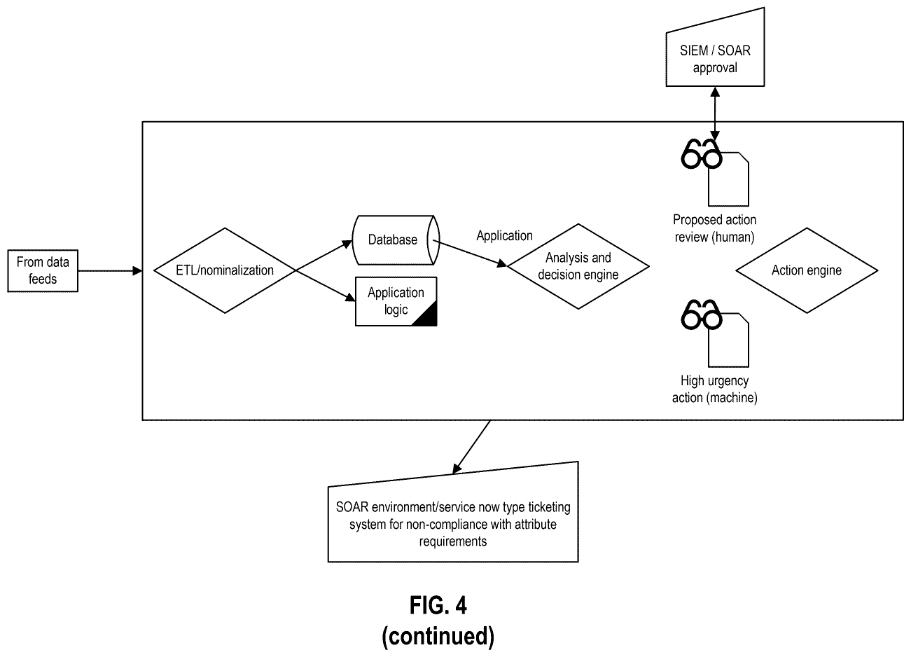

Various operations described below may be performed with respect to a collection of data. This data may include one or more different types of data, depending on the approach, e.g., user data, backup copy data, metadata, textual data, images, etc. In some approaches, the collection of data includes all data that is used within a data storage environment, where the collection of data is stored on a plurality of data storage devices. In some other approaches, the collection of data is data owned a company and/or data associated with a service offered by a company, e.g., such as a cloud storage service provider. It should be noted that infrastructure associated with the collection of data, in some approaches, is further detailed elsewhere herein, e.g., see FIG. 4.

With continued reference to FIG. 3, method 300 includes analyzing a plurality of data feeds, e.g., see operation 302. For context, a data feed, in some approaches, refers to an information stream that is subject to change over time as conditions change. In some preferred approaches, at least some of the data feeds correspond to use of different tooling to manage the collection of data. Information of these data feeds is subject to change over time for one reason or another, e.g., use cases of the data change, security rules for protecting the collection of data change, a location at which different portions of data of the collection of data are stored and/or are used change, the collection of data is modified, some data of the collection of data is deleted, etc. In the context of data storage, tooling may be defined as the software tools, services and/or hardware infrastructure used to manage, process, and analyze the collection of data. Depending on the approach, this tooling may include data acquisition commands, storage devices, trained models, analysis code, visualization operations, etc.

In some approaches, the tooling is caused, e.g., instructed, to over time collect and/or report on different portions of the data of the collection of data. This way, the data feeds provide accurate and dynamically updated information about the data that can be used to secure the collection of data, as well as reduce latencies within use of the collection of data. Accordingly, in some preferred approaches, a result of the analysis includes groups of features detected within the data feeds. These features detail characteristics of a topic of the tooling (classifications, security, full-stack observability, etc.) that may be used to determine and define an interconnected nature of relationships of the different tooling resources. In other words, the analysis extracts identifying characteristics within the information of each data feed that is then used to map (e.g., via clustering, determined causality, etc.) the data feed to other data feeds. Various use case examples of the data feeds and information associated therewith are described below.

In some approaches, the data feeds corresponding to the use of different tooling to manage the collection of data comprise a first data feed that details information about a workload discovery and classification tooling. For context, the workload discovery and classification tooling may be used in a data storage environment to identify new data introduced into the data storage environment and furthermore to classify the identified data that is then added to the collection of data. The workload discovery, in some approaches, includes identifying expenditures of processing resources, and for the expenditures, entering tickets that detail performed work tasks in order to establish historical workload information about tasks performed with data in the data storage environment. Data classification techniques of a type that would become apparent to one of ordinary skill in the art after reading the descriptions herein may be incorporated into this tooling, e.g., sensitivity based trained determination models, security based trained determination models, clustering algorithms (such as K-means clustering), etc. With respect to the first data feed, a group of features that may result from performing the analysis may, in some approaches, include metrics that detail any one or more of the data classifications, historical workload information about tasks performed, tickets, etc., mentioned above.

In another approach, the data feeds corresponding to the use of different tooling to manage the collection of data may additionally and/or alternatively comprise a second data feed that details information about security monitoring tools. These security monitoring tools may, in some approaches, be tools that are already deployed within the data storage environment to secure at least some data of the collection of data. For example, in some approaches, the security monitoring tools include authentication programs that restrict and/or allow access to data of the collection of data. Information associated with these tools may include, e.g., passwords, historical timestamps of accesses to portions of the collection of data, access credential details for different users, roles that are allowed to access restricted portions of the collection of data, etc. These security monitoring tools of a type that would become apparent to one of ordinary skill in the art after reading the descriptions herein may be used to provide information about in second data feed. With respect to the second data feed, a group of features that may result from performing the analysis may, in some approaches, include metrics that detail any one or more of the authentication information, information associated with the tools mentioned above, etc.

In yet another approach, the data feeds corresponding to the use of different tooling to manage the collection of data may additionally and/or alternatively comprise a third data feed that details information about full-stack observability tooling. For context, the information about full-stack observability tooling may map workload placement and relationships within an environment (e.g., the data storage environment) that the collection of data is used. With respect to the third data feed, a group of features that may result from performing the analysis may, in some approaches, include metrics that detail workload performance (such as of a server), (time consumed, number of tasks performed, location of tasks performed, throughput statistics, etc.), relationships between storage devices (tasks division among different storage devices and/or processors, etc.), etc. In some preferred approaches, the metrics may additionally and/or alternatively detail compliance, and more specifically, metrics that define whether data is being used in compliance with policies and/or requisite security controls based on policy/governance/data (e.g. protecting Personally identifiable information (PII)).

The data feeds corresponding to the use of different tooling to manage the collection of data may additionally and/or alternatively comprise a fourth data feed that details information about application dependency mapping tooling. For context, information about application dependency mapping may detail how different applications interoperate during historical use of the collection of data. In some approaches, workload division to achieve performance of parallel computations may be detailed within this information, e.g., such as where applications offload at least some tasks to other applications and/or infrastructure components in the process of performing a workload. With respect to the fourth data feed, a group of features that may result from performing the analysis may, in some approaches, include metrics that detail the dependency information described above and/or other types of dependency information of a type that would become apparent to one of ordinary skill in the art after reading the descriptions herein.

In some other approaches, the data feeds corresponding to the use of different tooling to manage the collection of data may additionally and/or alternatively comprise a fourth data feed that details information about compliance. An example of why application data mapping can be useful, in some approaches, may be based on PII that is (according to governing rules) now allowed to leave certain geographic boundaries. Accordingly, this information about compliance may be used to detect and/or determine whether an application or microservice is calling another application or microservice (sending PII as data) where that data may be stored outside the geographic boundary.

The data feeds corresponding to the use of different tooling to manage the collection of data may additionally and/or alternatively comprise a fifth data feed that details information about primary storage placement and policy information associated with the collection of data. A group of features that may result from performance of the analysis may, in some approaches, include metrics that detail platform identifiers, compliance violation events, compliance adherence statistics, performance of tasks and/or hardware and/or software during the performance of tasks associated with use of the collection of data, replication details and/or storage locations, immutable copy management tasks and/or storage locations, etc.

The data feeds corresponding to the use of different tooling to manage the collection of data may additionally and/or alternatively comprise a sixth data feed that details information about secondary storage and archive tooling associated with the collection of data. Various tooling resources that may be associated with the secondary storage and archive tooling associated with the collection of data may include, e.g., backup management resources, copy resources, replication resources, retention RBAC resources, geo-location placement resources, etc. A group of features that may result from performance of the analysis may, in some approaches, include metrics that detail the tasks performed by one or more of the tooling resources mentioned above.

Operation 304 includes causing an artificial intelligence (AI) model to use the groups of features to define a context associated with the collection of data. Note that the groups of features may, in some approaches, additionally and/or alternatively include information used in the analysis of the data feeds. It should also be noted that, defining the context associated with the collection of data more specifically defines the collection of data as an “entity” to thereby enable use of the entity to be monitored and controlled in an interconnected sense (interconnected with respect to the different types of data feeds) to prevent use case actions of a first of the data feeds from ever conflicting with use case actions and/or requirements the other data feeds.

In some approaches, the AI model may define the context associated with the collection of data by creating a workload and/or data asset in the context of an entity that comprises a classification of the collection of data (or different classifications), a placement of the data within the data storage environment, a dependency mapping of applications that use the collection of data, and storage policies within the data storage environment. Note that this context, in some approaches, refers to the collection of data with respect to an entire stack and active lifecycle of the data, e.g., historical use of the collection of data until the present. Various operations of method 300 described below enable integrations and linkages for this entity with a connectivity analysis that supports the entity (throughout use of the collection of data over time).

In order to support the collection of data (secure the entity across all use cases of the collection of data), in some approaches, method 200 includes assigning attribute policies to the groups of features, where the attribute policies are tailored to promote adherence to the context associated with the collection of data, e.g., see operation 306. For context, the attribute policies may be defined as a collection of rules that when applied ensure that use of the collection of data adheres to the context associated with the collection of data. Accordingly, in some approaches, method 300 includes causing a rule generating engine to generate the attribute policies based on the groups of features. A rule generating engine of a type that would become apparent to one of ordinary skill in the art may be used.

In one example, a first of the attribute policies may specify that a workload is to be accessible to user devices having a least a predetermined threshold degree of credentials, e.g., different role based access control (RBAC) credentials. Other examples of the first attribute policy may specify a range of times that access to a given portion of the collection of data is to be determined normal, a range of times that access to a given portion of the collection of data is to be determined abnormal, an average download data size, an average upload data size, etc. The first attribute policy may be assigned to a group of features associated with security monitoring tools. In another example, a second of the attribute policies may specify that primary storage placement operations are to be performed to a relatively highest performing tier of a tiered data storage system. The second attribute policy may be assigned to a group of features associated with the full-stack observability tooling. The second the attribute policy may additionally and/or alternatively specify storage based rules, e.g., placement and alignment with backup policies, placement and alignment with archive policies, etc. In another example, a third of the attribute policies may specify applications that must have access to a given portion of the collection of data in order to ensure different applications to interoperate according to historical use of the collection of data. The third attribute policy may be assigned to a group of features associated with the application dependency mapping tooling.

In order to ensure that none of the attribute policies violate a sub-portion of the context associated with the collection of data, in some approaches, the AI model is trained to, and instructed to, perform logical conflict checks between actions that are deemed to adhere to one or more of the attribute policies. While performing these logical conflict checks, one or more of the attribute policies may be determined to, if enforced and/or followed, conflict with another of the attribute policies. These conflicting attribute policies may be input into a trained logical reasoning model of a type that would become apparent to one of ordinary skill in the art after reading the descriptions herein. An output of the trained logical reasoning model, in some approaches, includes new attribute policies that adhere to each of the other attribute policies.

Operation 308 includes causing the AI model to monitor for deviations from the attribute policies during the management of the collection of data. Deviation from the attribute policies is, in some approaches, defined according to mathematical values, e.g., exceeding predetermined thresholds of deviation. These thresholds may be dynamically adjusted for one or more reasons, e.g., increased in strictness in response to a threat event occurring, decreased in response to a determination that processing resources available within the data storage system fall below a predetermined threshold, increased and/or decreased according to security requirements of data that are present in the collection of data, etc.

Monitoring for the deviations from the attribute policies during the management of the collection of data, in some approaches, includes comparing current information of the data feeds with historical information of the data feeds. In some approaches, the deviation from the first attribute policy during the management of the collection of data is based on a location of a first workload of the collection of data having greater than a threshold degree of similarity with historical locations of historical workloads of the collection of data. In another approach, the deviation from the first attribute policy during the management of the collection of data may additionally and/or alternatively include accessibility of a workload not adhering to a first of the attribute policies (such as the one or more attribute policies described elsewhere herein). In yet another approach, the deviation from the first attribute policy during the management of the collection of data may additionally and/or alternatively include primary storage placement during the management of the collection of data not adhering to a second of the attribute policies (such as placement and alignment with backup or archive policies). In yet another approach, the deviation from the first attribute policy during the management of the collection of data may additionally and/or alternatively include protection policies followed during the management of the collection of data not adhering to a third of the attribute policies (such as immutable copies, placement and alignment with backup or archive policies). These attribute policies, in some preferred approaches, ensure that use of the collection of data adheres to geographical rules and/or data sovereignty rules. In other words, in one or more of such approaches, the attribute policies are modified and applied according to different governing rules that data is subject to across different geographical regions, e.g., the California Consumer Privacy Act (CCPA). In this example, the data feeds are analyzed and geographical location is extracted therefrom in order to determine and enact enforcement of these geographically-based attribute policies.

A determination is made, based on the monitoring, as to whether a deviation from one or more of the attribute policies exists during the management of the collection of data (identified during monitoring performed during ongoing use of the collection of data), e.g., see decision 310. In response to a determination that no such deviation exists, e.g., as illustrated by the “NO” logical path of decision 310, monitoring optionally continues. In some other approaches, in response to a determination that no such deviation exists, thresholds used in the attribute policies may be increased (e.g., made relatively stricter) until a deviation is identified.

In response to identifying deviation from a first of the attribute policies during the management of the collection of data, e.g., as illustrated by the “YES” logical path of decision 310, an Application Programming Interface (API) action is driven to correct (mitigate) the deviation, e.g., see operation 312. In other words, the API action is driven to cause alignment of the ‘entity’ into proper enforcement policies. Each of these attribute policies thereby protect the collection of data without interfering with another of the attribute policies. By protecting the collection of data, the degree of risk that data is not protected, supported, managed, or even available for recovery in a cyber resiliency event according to business control and regulatory guidelines is mitigated. This also reduces response events that are otherwise performed in response to detection of a data loss or corruption event (thereby reducing potential workload impact computing operations that would otherwise take days to even weeks to perform).

Different API actions are, in some approaches, pre-associated with different potential ranges of deviation from the attribute policies. Furthermore, in some preferred approaches, the attribute policies that each of the API actions are pre-associated with are related to the API actions. For example, API actions that are based on adjusting access to at least some of the collection of data may be pre-associated with security based attribute policies. This way different degrees of response associated with the different API actions may be pre-associated with security based attribute policies according to similar degrees of security violations.

The driving the API action to correct the deviation from the first attribute policy, in some approaches, comprises causing (e.g., instructing) the AI model to identify user devices performing the first workload, and revoking access, of the identified user devices, to the collection of data. Revoking user device access to the collection of data in response to identifying such user devices violating the first attribute policy ensures that the user devices are not able to maliciously exploit the collection of data. The driving the API action may additionally and/or alternatively include generating a report detailing the deviation from the first attribute policy, e.g., timestamps, degrees that the policy was violated, identities of the users using the user devices at the time the policy was violated, etc. The driving the API action, in some approaches, additionally and/or alternatively includes logging the report. In some approaches, the logging includes adding the report to a training set of data used to train a second AI model that is deployable to a second data storage environment (in response to the second AI model achieving at least a predetermined degree of accuracy while observing the first AI model and training on the training set of data). The logging the report may additionally and/or alternatively include storing the report on a blockchain and/or ledger of the blockchain and/or copy of the ledger of the blockchain to ensure that the API action response remains auditable.

In some other approaches, the driving the API action to correct the deviation from the first attribute policy may additionally and/or alternatively include enforcing a re-authentication policy against the identified user devices, reducing role based access control (RBAC) credentials for users associated with the identified devices, generating a report that details a corruption impact on entities impacted by the deviation, etc. Note that, in some approaches, the first attribute policy is selected from the group of actions consisting of one or more of the examples provided above.

In some approaches, a result of the driving the API action to correct the deviation comprises a mapping of data loss from the collection of data that results from the deviation from a first of the attribute policies (e.g., exfiltration). The result may, in some approaches, additionally and/or alternatively includes a report that details a corruption impact based on affected entities, e.g., owners of the data, hardware components of the data storage environment, etc. Findings of this report may, in some approaches, be generated based on an audit scan being run on the data storage environment, where the scan may be of a type that would become apparent to one of ordinary skill in the art after reading the descriptions herein.

In some approaches, one or more of the operations of method 300 may be performed by the AI model (which may be a trained engine for protecting the collection of data) which may be trained using a predetermined training set of data. For example, in some approaches, various of the operations noted above may be deployed in a trained state of a trained AI model. Training of the AI model, in some approaches, may be performed by using a training set of data to train the AI model to use groups of test features to define a test context associated with the training set of data. Initial training may include reward feedback that may, in some approaches, be implemented using a subject matter expert (SME). However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300. More specifically, in some approaches, in response to a determination that the AI model achieves at last a threshold degree of accuracy in defining the test context, the AI model is deployed to use the groups of features to define a context associated with the collection of data, e.g., see operation 304. In some further approaches, the AI model may be a neuromyotonic AI model that may improve performance of computer devices in an infrastructure associated with the data storage environment, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from a customer and/or owner of at least some data of the collection of data. Such an AI model ensures that the context is ongoingly accurate, where the scale of such analysis and determinations would not otherwise be feasible for a human to perform. This is because humans are not able to efficiently monitor data feeds in real time at the scale described herein, and would otherwise incorporate processing delays and errors in the process of method 300 in attempting to do so. Accordingly, management of operations described herein is not able to be achieved by human manual actions.

FIG. 4 depicts a data storage environment 400 for determining and enforcing attribute policies tailored to protect a collection of data, in accordance with one embodiment. As an option, the present data storage environment 400 may be implemented in conjunction with features from any other embodiment listed herein, such as those described with reference to the other FIGS. Of course, however, such data storage environment 400 and others presented herein may be used in various applications and/or in permutations which may or may not be specifically described in the illustrative embodiments listed herein. Further, the data storage environment 400 presented herein may be used in any desired environment.

The data storage environment 400, in some approaches, includes data sources in which a collection of data is stored and/or which data feeds 406 may be based on. For example, the data storage environment 400 includes a primary data source 402 which includes a plurality of infrastructure and storage components, e.g., see Datacentre VM/Physical Machines, Removable Media, Block Storage Array, file storage system, etc. The data storage environment 400 further includes a second data source 404 which may serve as serve as primary storage snapshots, backup storage (secondary) and/or archive storage to the primary data source 402 and includes a plurality of infrastructure and storage components, e.g., see HSM, archive, etc. Discovery engines (of a type that would become apparent to one of ordinary skill in the art after reading the descriptions herein) may be configured to mine the storage sources to obtain data feeds corresponding to use of different tooling to manage the collection of data stored on the storage sources, e.g., see Discovery Engine.

The data feeds, in some approaches, correspond to use of different tooling to manage the collection of data, e.g., see Data classification tooling, Security data monitoring tooling, Full stack visibility analysis tooling, Full stack observability tooling, Existing Security Config(Processed Metadata), Detected Datatypes (Indexed Data Content), etc. One or more of these tools may be used to generate and/or analyze a data feed to determine characteristics such as, e.g., frequency of snapshots/backups, retention times, immutability or air gap configurations, etc. Accordingly, in some approaches, the tooling is used to preprocess the collection of data and/or generate information about use of the collection of data that is then analyzed.

The data feeds may, in some approaches, be analyzed using techniques similar to those described elsewhere above. In some approaches, the analysis includes metadata analysis for metadata that is extracted from one or more of the data feeds. The analysis may additionally and/or alternatively include deep index analysis and/or detection, in some approaches. In some further approaches, the analysis of the data feeds may include performing transformative data processes for streamlining data analysis and reducing an amount of data processed. For example, the analysis may include performing Extract, Transform, Load (see ETL/nominalization), which may include a data integration process that transfers data from the different sources, filters and transforms the collection of data, and then loads the resulting transformed collection of data into a database, e.g., see Database.

In some approaches, a result of this analysis, e.g., ETL/nominalization, includes groups of features detected within the data feeds that are then stored in the database. Application logic may then be executed to process contents of the database, e.g., executed by an AI model that is configured to perform operations described elsewhere above in method 300. For example, the AI model may act as an analysis and decision engine that uses the groups of features to define a context associated with the collection of data. This context describes an interconnected nature of the different uses of the collection of data, and is used to assign attribute policies to the groups of features, where the attribute policies are tailored to promote adherence to the context associated with the collection of data. For context, in some approaches, attributes are assigned for each detected feature of the data storage environment 400. The attribute policies may require certain configuration options such as a PII attribute policy=TRUE that represents that a certain security measure is needed for at least a portion of the collection of data, e.g., encryption requirements, backup requirements, etc.

The AI model may be caused to monitor for deviations from the attribute policies during the management of the collection of data, e.g., see Analysis and decision engine. In response to identifying deviation from one or more of the attribute policies during the management of the collection of data, API actions may be driven to correct the deviation. For example, an action engine may be used to determine such API actions. A first of these actions, in some approaches, includes a proposed action which may be subject to review by a SME, e.g., see SIEM/SOAR approval. In some approaches, the action calls for security action approval (two person integrity) review of proposed policy placement change. In some other approaches, cybersecurity tools, e.g., see security information and event management (SIEM) and security orchestration, automation, and response (SOAR), may be used for providing alerting about such deviation. In some approaches, compromised workloads may be fed directly to an analysis engine to identify impact of deviation events and/or for forensic analysis.

The API actions may additionally and/or alternatively include relatively high urgency actions that are performed by a machine, e.g., reboot, disconnect from a network, terminate connection with one or more user devices, etc. In some approaches, the API actions may additionally and/or alternatively include generating a report and/or ticket that details the deviation, e.g., in a SOAR environment/service now type ticketing system may be deployed for identified non-compliance with attribute policy requirements.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
analyzing a plurality of data feeds, the data feeds corresponding to use of different tooling to manage a collection of data;
wherein a result of the analysis includes groups of features detected within the data feeds;
causing an artificial intelligence (AI) model to use the groups of features to define a context associated with the collection of data;
assigning attribute policies to the groups of features, wherein the attribute policies are tailored to promote adherence to the context associated with the collection of data; and
in response to identifying deviation from a first of the attribute policies during the management of the collection of data, driving an Application Programming Interface (API) action to correct the deviation.

2. The method of claim 1, further comprising:
using a training set of data to train the AI model to use groups of test features to define a test context associated with the training set of data; and
in response to a determination that the AI model achieves at last a threshold degree of accuracy in defining the test context, deploying the AI model to use the groups of features to define a context associated with the collection of data.

3. The method of claim 1, wherein the data feeds corresponding to the use of different tooling to manage the collection of data comprise: a first data feed that details information about a workload discovery and classification tooling, a second data feed that details information about security monitoring tools, and a third data feed that details information about full-stack observability tooling that maps workload placement and relationships within an environment that the collection of data is used.

4. The method of claim 3, wherein the data feeds corresponding to the use of different tooling to manage the collection of data comprise: a fourth data feed that details information about application dependency mapping tooling, a fifth data feed that details information about primary storage placement and policy information associated with the collection of data, and a sixth data feed that details information about secondary storage and archive tooling associated with the collection of data.

5. The method of claim 1, further comprising:
causing the AI model to monitor for deviations from the attribute policies during the management of the collection of data; and
wherein the deviation from the first attribute policy during the management of the collection of data is based on a location of a first workload of the collection of data having greater than a threshold degree of similarity with historical locations of historical workloads of the collection of data.

6. The method of claim 5, wherein the driving the API action to correct the deviation from the first attribute policy comprises: causing the AI model to identify user devices performing the first workload; revoking access, of the identified user devices, to the collection of data; generating a report detailing the deviation from the first attribute policy; and logging the report.

7. The method of claim 6, wherein the driving the API action to correct the deviation from the first attribute policy is selected from the group of actions consisting of:
enforcing a re-authentication policy against the identified user devices, reducing role based access control (RBAC) credentials for users associated with the identified devices, and generating a report that details a corruption impact on entities impacted by the deviation.

8. The method of claim 1, wherein the deviation from the first attribute policy during the management of the collection of data is selected from the group consisting of:
accessibility of a workload not adhering to a first of the attribute policies, primary storage placement during the management of the collection of data not adhering to a second of the attribute policies, and protection policies followed during the management of the collection of data not adhering to a third of the attribute policies.

9. The method of claim 1, wherein a result of the driving the API action to correct the deviation comprises a mapping of data loss from the collection of data that results from the deviation from a first of the attribute policies.

10. A computer program product comprising:
one or more computer-readable storage media; and
program instructions stored on the one or more storage media to perform operations comprising:
analyzing a plurality of data feeds, the data feeds corresponding to use of different tooling to manage a collection of data;
wherein a result of the analysis includes groups of features detected within the data feeds;
causing an artificial intelligence (AI) model to use the groups of features to define a context associated with the collection of data;
assigning attribute policies to the groups of features, wherein the attribute policies are tailored to promote adherence to the context associated with the collection of data; and
in response to identifying deviation from a first of the attribute policies during the management of the collection of data, driving an Application Programming Interface (API) action to correct the deviation.

11. The computer program product of claim 10, wherein the operations further comprise:
using a training set of data to train the AI model to use groups of test features to define a test context associated with the training set of data; and
in response to a determination that the AI model achieves at last a threshold degree of accuracy in defining the test context, deploying the AI model to use the groups of features to define a context associated with the collection of data.

12. The computer program product of claim 10, wherein the data feeds corresponding to the use of different tooling to manage the collection of data comprise: a first data feed that details information about a workload discovery and classification tooling, a second data feed that details information about security monitoring tools, and a third data feed that details information about full-stack observability tooling that maps workload placement and relationships within an environment that the collection of data is used.

13. The computer program product of claim 12, wherein the data feeds corresponding to the use of different tooling to manage the collection of data comprise: a fourth data feed that details information about application dependency mapping tooling, a fifth data feed that details information about primary storage placement and policy information associated with the collection of data, and a sixth data feed that details information about secondary storage and archive tooling associated with the collection of data.

14. The computer program product of claim 10, wherein the operations further comprise:
causing the AI model to monitor for deviations from the attribute policies during the management of the collection of data; and
wherein the deviation from the first attribute policy during the management of the collection of data is based on a location of a first workload of the collection of data having greater than a threshold degree of similarity with historical locations of historical workloads of the collection of data.

15. The computer program product of claim 14, wherein the driving the API action to correct the deviation from the first attribute policy comprises: causing the AI model to identify user devices performing the first workload; revoking access, of the identified user devices, to the collection of data; generating a report detailing the deviation from the first attribute policy; and logging the report.

16. The computer program product of claim 15, wherein the driving the API action to correct the deviation from the first attribute policy is selected from the group of actions consisting of: enforcing a re-authentication policy against the identified user devices, reducing role based access control (RBAC) credentials for users associated with the identified devices, and generating a report that details a corruption impact on entities impacted by the deviation.

17. The computer program product of claim 10, wherein the deviation from the first attribute policy during the management of the collection of data is selected from the group consisting of: accessibility of a workload not adhering to a first of the attribute policies, primary storage placement during the management of the collection of data not adhering to a second of the attribute policies, and protection policies followed during the management of the collection of data not adhering to a third of the attribute policies.

18. The computer program product of claim 10, wherein a result of the driving the API action to correct the deviation comprises a mapping of data loss from the collection of data that results from the deviation from a first of the attribute policies.

19. A computer system comprising:
a processor set;
one or more computer-readable storage media; and
program instructions stored on the one or more storage media to cause the processor set to perform operations comprising:
analyzing a plurality of data feeds, the data feeds corresponding to use of different tooling to manage a collection of data;
wherein a result of the analysis includes groups of features detected within the data feeds;
causing an artificial intelligence (AI) model to use the groups of features to define a context associated with the collection of data;
assigning attribute policies to the groups of features, wherein the attribute policies are tailored to promote adherence to the context associated with the collection of data; and
in response to identifying deviation from a first of the attribute policies during the management of the collection of data, driving an Application Programming Interface (API) action to correct the deviation.

20. The computer system of claim 19, wherein the operations further comprise:
using a training set of data to train the AI model to use groups of test features to define a test context associated with the training set of data; and
in response to a determination that the AI model achieves at last a threshold degree of accuracy in defining the test context, deploying the AI model to use the groups of features to define a context associated with the collection of data.
